(19) United States
(12) Patent Application Publication
(10) Pub. No.: US 2008/0240385 A1
(43) Pub. Date: Oct. 2, 2008

(54) Black phone presence services

(75) Inventor: Vladimir Mikhailov, San Jose, CA (US)

Correspondence Address: STINSON MORRISON HECKER LLP;ATTN: PATENT GROUP, 1201 WALNUT STREET, SUITE 2800, KANSAS CITY, MO, 64106-2150, US

(73) Assignee: Veraz Networks, Inc.

(21) Appl. No.: 11/731,147

(22) Filed: Mar. 30, 2007

(51) Int. Cl. H04M 1/64

(52) U.S. Cl. 379/88.25

(57) ABSTRACT

Techniques for providing presence services to black phones are described herein. According to one embodiment, a call is received from a caller party to a called party, where the call is originated from a POTS device that is not capable of handling IMS protocols. In response to the call, a presence service provider is used to retrieve presence information about the called party using the IMS protocols, where the presence information indicates a current presence state of the called party. Then the current presence state of the called party is announced to the caller party by playing a prerecorded voice message representing the current presence state of the called party. Other methods and apparatuses are also described.

### FIELD OF THE INVENTION

The present invention relates generally to telecommunications. More particularly, this invention relates to providing presence services to black phones.

### BACKGROUND

Presence is NGN (next generation network) service defined and standardized in IMS (IP multimedia subsystem) architecture. Presence is a super-service, with capability to define dynamic user behavior and adjust services behavior to fit user status, device capabilities and user environment. Most presence implementations are heavily relying on sophisticated GUI (graphical user interface) of user terminals (e.g., soft phones, personal digital assistant or PDA, cellular phones, etc.) to realize complicated logic of service usage. Such terminals are usually capable of sending notifications, accept invitations to the presence list, watching numerous presence states, and performing other sophisticated operations.

However, there has been lack of supports of presence for traditional phones such as POTS (plain old telephony service) phones that do not possess the sophisticated GUI required by the presence service, particularly, over an IMS network.

### SUMMARY OF THE DESCRIPTION

Techniques for providing presence services to black phones are described herein. According to one embodiment, a call is received from a caller party to a called party, where the call is originated from a POTS device that is not capable of handling IMS protocols. In response to the call, a presence service provider is used to retrieve presence information about the called party using the IMS protocols, where the presence information indicates a current presence state of the called party. Then the current presence state of the called party is announced to the caller party by playing a prerecorded voice message representing the current presence state of the called party.

Other features of the present invention will be apparent from the accompanying drawings and from the detailed description which follows.

### DESCRIPTION OF THE DRAWINGS

The present invention is illustrated by way of example and not limitation in the figures of the accompanying drawings in which like references indicate similar elements.

FIG. 1 is a block diagram illustrating an IMS network configuration according to one embodiment of the invention.

FIG. 2 is a flow diagram illustrating a process for providing presence services to POTS devices according to one embodiment of the invention.

FIG. 3 is a flow diagram illustrating a process for providing presence services to POTS devices according to one embodiment of the invention.

FIG. 4 is a block diagram illustrating a system for providing presence services to POTS device according to one embodiment of the invention.

### DETAILED DESCRIPTION

Techniques for providing presence services to black phones are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

As mentioned above, most presence implementations are heavily relying on sophisticated GUI interfaces of user terminals (e.g., soft phones, PDA, cellular phones, etc.) to realize complicated logic of service usage. Such terminals are usually capable of sending notifications, accepting invitations to the presence list, watching numerous presence states, and performing other sophisticated operations.

Presence architecture defines roles of presence watcher and presence user agent, presence agent (e.g., application server) often referred to as a presence server. Presence architecture also defines a resource list server (RLS) as an application server. A user through offered by interactive devices capabilities and IMS defined protocols (e.g., XCAP, SIP, etc.) defines the configuration of presence lists and authorizes watchers, etc. IMS framework defines SIP based mechanism of subscribe/notify as a main mechanism for a user to participate in sharing of the user's presence and to benefit from knowing presence of other members of the presence list. RLS is a main network entity for this mechanism.

It is fair to state that presence was mainly intended for computer users. Thus, this is a perfect service for sophisticated markets with strong base of computer users. Contrary to this, in many developing markets POTS phone (also referred to as black phone) remains the main device for telephony services, and there is only slim chance to benefit from the IMS services.

A black phone is a poor interactive device for presence; however, it should not be completely dismissed and there are indications of a long future of these devices due to several strong factors. For example, a black phone has a relatively low device price and there are plenty of black phone devices already available. In addition, a black phone is a simple device and there are many acoustic characteristics that modern sophisticated devices lack. Further, a black phone has a right size for a wide range of users including those with eyes/hearing or other physical limitations. It is still a top telephony device in the developing markets for land-line telephony. One of most desirable ways for IMS to have substantial impact in the developing markets (before any sophisticated FMC or fixed/mobile convergence will take hold) is to provide IMS services (e.g., presence services) to black phones.

According to certain embodiments of the invention, a special centralized application server (e.g., SIP (Session Initiation Protocol) Application Server) within a framework of IMS architecture is used to provide presence services for devices without sophisticated GUI presentation and control (e.g., black phones). This application server may serve as a presence proxy for the black phone devices. In addition, a Media Server may be utilized to generate interactive voice information for users of black phones for purpose of interaction required by presence service logic, such as, for example, announcing current device presence state with help of the media server and announcing the presence state of a party in a call attempt before processing the call.

According to an alternative embodiment, an IAD/ATA device interfacing the black phone with IMS network may be used to performing the announcements of presence states. For example, the IAD/ATA device may download certain voice messages corresponding to certain presence states and perform the announcement by playing the downloaded voice messages.

According to another embodiment, a mechanism is provided to allow a user of a black phone to join a swatch list and to set up presence states in order to allow other parties in the IMS network to retrieve such presence information and determine a current presence state of the user of the black phone.

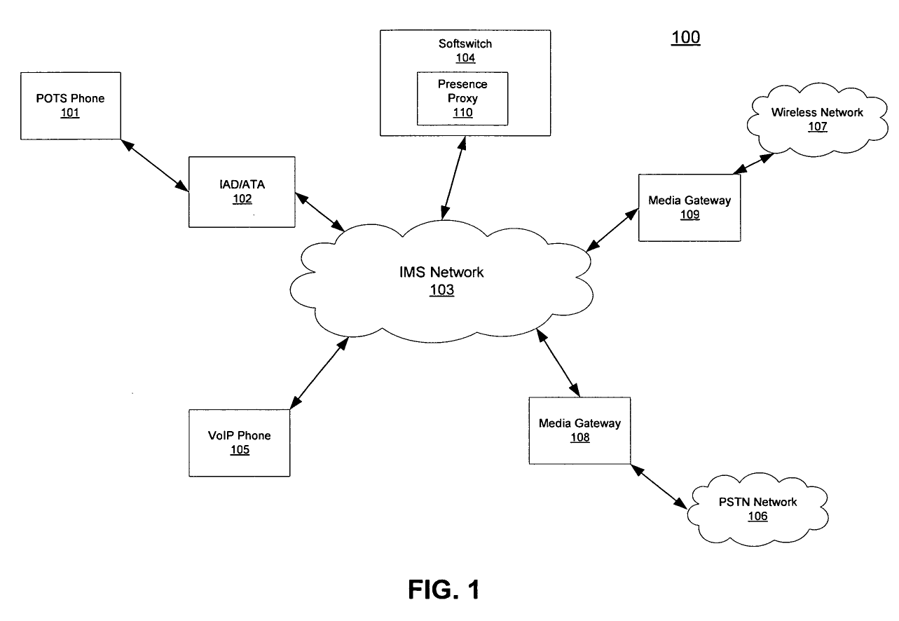

FIG. 1 is a block diagram illustrating an IMS network configuration according to one embodiment of the invention. Referring to FIG. 1, network configuration 100 includes, but is not limited to, a softswitch 104 coupled to an IMS network 103 to mediate between various packet and circuit based networks, such as wireless network 107 and PSTN network 106 via media gateways 108-109, as well as POTS phone 101 via IAD/ATA 102 and other voice over IP (VoIP) phones.

Typically, softswitch 104 is a central device in a telephone network which connects calls from one phone line to another, entirely by means of software running on a computer system. This work was formerly carried out by hardware with physical switchboards to route the calls. A softswitch is typically used to control connections at the junction point between circuit and packet networks. A single device containing both the switching logic and the switching fabric can be used for this purpose; however, modern technology has led to a preference for decomposing this device into a call agent and a media gateway. Softswitch 104 may be, for example, ControlSwitch™ available from Veraz Networks of San Jose, Calif.

IMS is an architectural framework, originally designed by the wireless standards body 3GPP (3rd generation partnership project), for delivering IP multimedia services to end users. Typically, devices use SIP over IP protocols to communicate with each other within the IMS network. The IP multimedia core network subsystem is a collection of different functions, linked by standardized interfaces, which grouped form one IMS administrative network. A function is not a node (hardware box). An implementer is free to combine 2 functions in 1 node, or to split a single function into 2 or more nodes. Each node can also be present multiple times in a single network, for load balancing or organizational issues.

Users can connect to an IMS network using various methods, all of which are using the standard IP. Direct IMS terminals (e.g., mobile phones, PDAs, computers), can register directly into an IMS network, even when they're roaming in another network or country (the visited network). The only requirement is that they can use IPv6 (also IPv4 in ‘Early IMS’) and are running SIP user agents. Fixed access (e.g., DSL, cable modems, Ethernet, etc.), mobile access (e.g., CDMA, GSM, GPRS, etc.) and wireless access (WLAN, WiMAX, etc.) are supported. Other phone systems like the POTS, H.323 and non IMS-compatible VoIP systems are supported through media gateways such as media gateways 108-109. Media gateways 108-109 may be, for example, I-Gate 4000 family gateway devices available from Veraz Networks of San Jose, Calif.

Referring back to FIG. 1, according to one embodiment, when POTS device 101 wishes to access IMS network 103, POTS device 101 contacts IAD/ATA device 102 associated with POTS device 101 using various signaling schemes, such as, for example, DTMF (dual-tone multi-frequency) signaling scheme. Typically, DTMF signaling is used for telephone signaling over the line in the voice-frequency band to the call switching center. The version of DTMF used for telephone tone dialing is known by the trademarked term Touch-Tone, and is standardized by ITU-T Recommendation Q.23. Other multi-frequency systems are used for signaling internal to the telephone network.

DTMF is an example of a multi-frequency shift keying (MFSK) system. Today DTMF is used for most call setup to the telephone exchange, at least in developed regions of the world, and trunk signaling is now done out of band using the SS7 (signaling system 7) signaling system. The in band trunk signaling tones were different from the DTMF tones known as touch-tone, with a two out of six code being used rather than a square matrix.

Referring back to FIG. 1, in response to the communications received from POTS device 101, IAD/ATA 102 is configured to interpret the DTMF signals and establishes a proper SIP session with softswitch 104 (e.g., SIP application server). IAD/ATA device 102 is configured to interface POTS device 101 with other parties or entities of the SIP/IMS network 103.

According to one embodiment, a user of POTS device 101 (also referred to as a caller party) contacts IAD/ATA 102 in an attempt to obtain presence information of a destination being called (also referred to as a called party) using various signaling protocols. In computer and telecommunications networks, presence information is a status indicator that conveys ability and willingness of a potential communication partner—for example a user to communicate. A user's client provides presence information (presence state) via a network connection to a presence service, which is stored in what constitutes his personal availability record (called a presentity) and can be made available for distribution to other users (called watchers) to convey his availability for communication. Presence information has wide application in many communication services and is one of the innovations driving the popularity of instant messaging or recent implementations of voice over IP clients.

A user client may publish a presence state to indicate its current communication status. This published state informs others that wish to contact the user of his availability and willingness to communicate. The most common use of presence today is to display an indicator icon on instant messaging clients, typically from a choice of graphic symbol with an easy-to-convey meaning, and a list of corresponding text descriptions of each of the states. Common states on the user's availability are “free for chat”, “busy”, “away”, “do not disturb”, “out to lunch”. Such states exist in many variations across different modern instant messaging clients. Current standards support a rich choice of additional presence attributes that can be used for presence information, such as user mood, location, or free text status.

Referring back to FIG. 1, in response to the call, IAD/ATA 102 establishes a SIP session with a presence server (e.g., an SIP server) managed by softswitch 104 using a presence service protocol according to the IMS framework. For example, IAD/ATA device 102 may determine identities of the caller party and called party and send a request to the presence server for requesting presence information of the called party which is identified by the called party's identity. The caller and called parties identity information may be embedded within the SIP communications between IAD/ATA 102 and the presence server.

It is assumed that the called party has set up or registered (e.g., publish) with the presence server previously within the framework of IMS architecture regarding called party's presence states. In response to the request, softswitch 104 invokes a presence server to retrieve presence information of the called party. In addition, according to one embodiment, softswitch 104 may invoke a presence proxy 10 to process or interpret using IMS protocols the presence information obtained from the presence server. Presence proxy 110 may in turn invoke a media server within framework of IMS to identify a voice message associated with the presence information, particularly, the current presence states of the called party and the media server performs the announcement representing the presence information or current presence states of the called party by playing the identified voice message. Based on the announcement made by the media server, a user of POTS phone 101 may obtain presence information of the called party.

According to another embodiment of the invention, presence proxy 110 may, via IAD/ATA device 102, provide a mechanism to allow a user of POTS phone 101 to set up its presence states in the IMS network. For example, IAD/ATA device 102 may use WSI or DTMF signaling schemes to communicate with POTS phone 101 to obtain presence information of the POTS phone 101. IAD/ATA device 102 may then communicate with the presence proxy which in turn communicates with the presence server using SIP over IP protocols within the IMS framework to set up presence information in the presence server. As a result, other parties within the IMS network may obtain the presence states of POTS phone 101. Other configurations may exist.

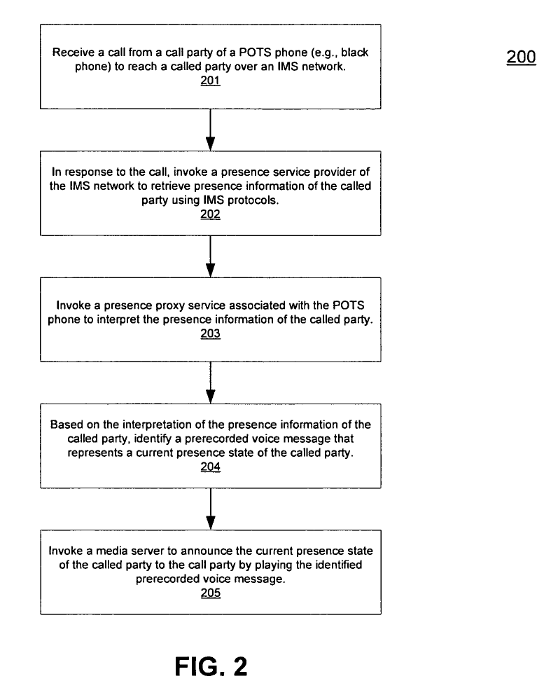

FIG. 2 is a flow diagram illustrating a process for providing presence services to POTS devices according to one embodiment of the invention. Note that process 200 may be performed by processing logic which may include software, hardware, or a combination of both. For example, process 200 may be performed by softswitch 104 and/or presence proxy 110 of FIG. 1. Referring to FIG. 2, at block 201, a phone call is received from a call party of a POTS phone in an attempt to reach a called party over an IMS network. The identities (e.g., caller ID) of the call party and called party may be obtained via various signaling schemes (e.g., DTMF). In response to the call, at block 202, a presence service provider (e.g., presence server) is invoked to retrieve presence information of the called party using IMS protocols (e.g., SIP over IP protocols). At block 203, a presence proxy is invoked to interpret the obtained presence information of the called party in view of the IMS framework. Based on the interpretation, at block 204, a prerecorded voice message is identified that represents the presence state obtained from the presence server. The voice message may also be generated dynamically using pieces of voice messages segments in response to the interpretation of the presence information. At block 205, an announcement is made to the user of POTS by playing the identified voice message. In one embodiment, the announcement is made via a media server within the IMS framework. In one embodiment, this may require announcement of called party name or other dynamic parameters (with service evolution) and in general usage of text-to-speech generator. Currently such generators are common capability of Media Servers.

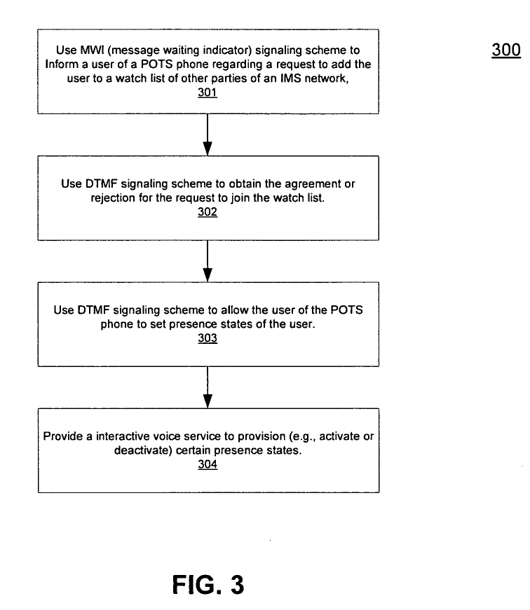

FIG. 3 is a flow diagram illustrating a process for providing presence services to POTS devices according to one embodiment of the invention. Note that process 300 may be performed by processing logic which may include software, hardware, or a combination of both. For example, process 300 may be performed by softswitch 104 and/or presence proxy 110 of FIG. 1. In this embodiment, a mechanism is provided for a user of POTS device to set up or provide presence information of the user in a presence server within the IMS framework.

One of the known and common problems of the voice services usage with black phone is difficulty to memorize all (*star) commands for services provisioning by user and as a result underutilization of services. Presence is a highly interactive service, which would require entering sufficient number of controls to use it. To make it friendly every step of usage is prompted with interactive hint of what actions are possible through announcement of list of actions and corresponding DTMF sequences. Experienced user may interrupt these prompt messages and enter command at any time. General help is also available by entering certain DTMF sequence (could be provisionable). General help explains what presence states are available and how to set them, what provisioning actions are available as well as other useful hints.

Message Waiting Indicator (MWI) is a general capability available on the black phones to indicate the user that new message is available. MWI is commonly used for new Voice Mail message notification in the modern black phones. There are two types of MWI a) visual—usually blinking lamp, b) audio—stutter tone on the lift of receiver. For the black phone Presence service, according to certain embodiments, existing MWI capabilities are used to notify the user about new system message available. The system message is usually a request of the other user (watcher) to allow adding requesting party to the watcher watch list. In one embodiment, the system prompts the user on possible responses, user decide on the response and enters corresponding DTMF sequence. Presence Proxy service acknowledges the DTMF command with appropriate acknowledgement announcements. Acknowledgments and prompts are important part of black phone Presence service to ensure interactivity, friendliness and high usability of service.

To further improve the service usability, according to certain embodiments of the invention, the following changes may be needed to the black phone: additional lamp or different color of MWI indicator for system messages. IAD/ATA may need the following change: different frequency of MWI stutter tone for system message indication.

Referring to FIG. 3, at block 301, a user of POTS device is informed regarding a request to add the user to a watch list of other parties within the IMS network, such that other parties can obtain the presence information of the user of a POTS device. In one embodiment, this operation may be performed via IAD/ATA device (e.g., IAD/ATA device 102 of FIG. 1) coupling the POTS device to IMS network. In one embodiment, WMI signaling scheme may be used to inform the user of POTS device. For example, the user is prompted with possible responses. At block 302, DTMF signal scheme is used to obtain an agreement or rejection from the user of the POTS device in response to the request. For example, DTMF sequence is provisionable and could be something like ##1—accept invitation, ##0—reject invitation, etc.

User enters general help DTMF sequence (f.e. ##*). At block 303, DTMF signaling scheme may be used to allow the user of a POTS device to set up presence information of the user in a presence server with corresponding DTMF sequence. At block 304, an interactive voice service may be used to provision (e.g., activate or deactivate) certain presence information or states. According to certain embodiments, the service may include two parts. Basic Presence may include generally encountered and most frequent availability states (available, not available, stepped away, not at the desk, etc.). Enhanced services may include delegation and time dependencies as well as other features (f.e. call my home number from 7 pm-9 pm). The prompt announcement may explain what DTMF sequence could set this service (f.e. for above option enter #* and 0 for AM (or 1 for PM) and one digit for the beginning of time interval, repeat the sequence for the end of time interval and ## and telephone number to call). Presence Proxy Server logic will know before redirection to announce to the calling party the call is redirected to the following number and in the given time interval. Speech Recognition could be used to improve interactivity and simplify complex cases provisioning. Speech Recognition capability is available on modern Media Servers. The use of Speech recognition is important direction of evolution; also it is not absolutely required to provide basic black phone Presence service. Other operations may also be performed.

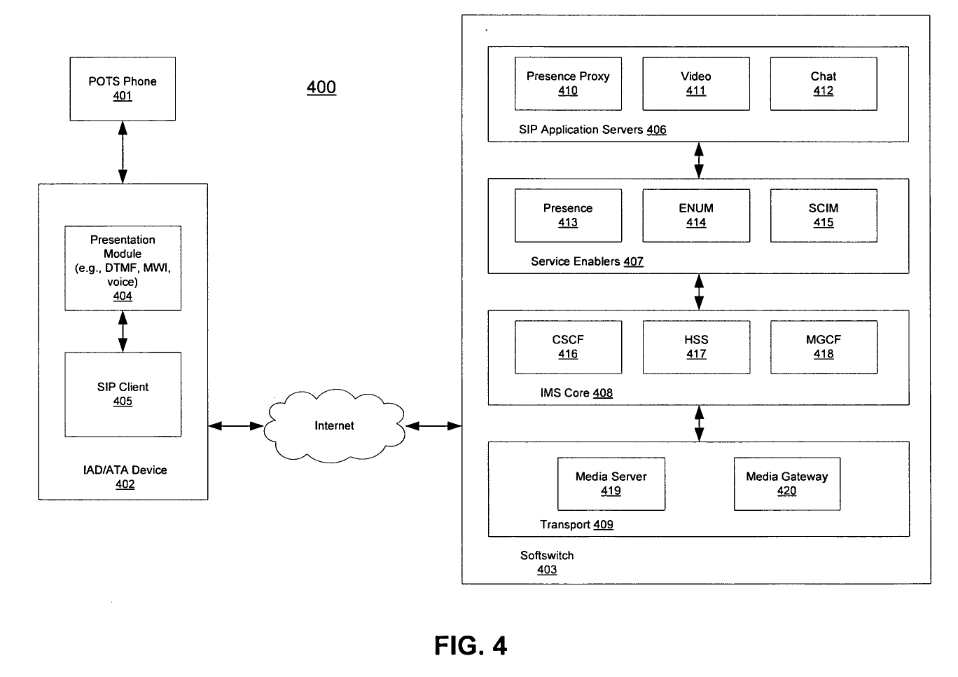

FIG. 4 is a block diagram illustrating a system for providing presence services to POTS device according to one embodiment of the invention. Referring to FIG. 4, system 400 includes, but is not limited to, a POTS device 401 coupled via IAD/ATA device 402 to a softswitch 403 over the Internet. IAD/ATA device 402 includes a presentation module 404 and an SIP client 405. Presentation module 404 is able to communicate with POTS phone using various signaling schemes such as DTMF, WMI, and voice, etc. SIP client 405 interfaces circuit based signals and packet based data with softswitch 403. Softswitch 403 may be a softswitch compatible with IMS framework. As part of IMS framework, softswitch 403 includes an application layer 406, a service layer 407, an IMS core layer 408, and a transport layer 409.

According to one embodiment, application layer 406 includes a variety of applications running therein including, for example, video application 411 and chatting application 412, etc. In addition, presence proxy 410 is running within the application layer. For example, presence proxy 410 may be implemented as part of presence proxy 110 of FIG. 1 to provide IMS presence services to POTS 401, using some or all of the techniques described above.

Service layer 407 includes a presence service module 413, a telephone number mapping (ENUM) service 414, and SCIM (service capability interaction management) module 415. As described above, presence server 413 is used to provide presence information of users who have published their presence states in the presence server 413. The information supplied by the user is stored in the user personal availability record and can be made available for distribution to other users to convey the user's availability. ENUM is a suite of protocols to unify the telephone numbering system E.164 with the Internet addressing system DNS (domain name service) by using an indirect lookup method to obtain NAPTR (naming authority pointer) records which may be stored in a DNS database. SCIM module 415 uses real-time service management and delivery, and enables blended services and legacy services integration. As it is based on the interaction model, the SCIM module 415 facilitates planning, implementing and service interactions at the service design time.

IMS core layer includes a CSCF (call session control function) 416, a HSS (home subscriber server) 417, and a MGCF (media gateway control function) 418. CSCF 416 is designed for registering users, providing services to the users even when these services reside on separate application platforms. CSCF 416 performs routing and translation; provides billing information; maintains session timers; and interrogates the HSS 417 to retrieve authorization, services triggering information, and user profiles. The HSS 417 houses the master user database that supports the IMS network entities that are actually handling the calls/sessions. HSS 417 contains the subscription-related information (user profiles), performs authentication and authorization of the user, and can provide information about the physical location of user. MGCF 418 communicates with CSCF 416 to control the connections for media channels in the media gateway functions (e.g., media gateway 420).

Transport layer 409 includes a media server 419 and mediate gateway 420. Media server 419 (also referred to as media resource function or MRF). An MRF provides a source of media in the home network. An MRF may be used for playing of announcements (audio/video), multimedia conferencing (e.g. mixing of audio streams), text-to-speech conversion (TTS) and speech recognition, and real-time transcoding of multimedia data (i.e. conversion between different codecs), etc. Media gateway 420 may be used to terminate bearer channels from a switched circuit network and media streams from a packet network. Media gateway 420 can support media conversion, bearer control, and payload processing such as codec, echo canceller, etc. Note that some of all of the components described above may be implemented in hardware, software, or a combination of both.

Thus, techniques for providing presence services to black phones have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for providing presence services to POTS (plain old telephony system) telephones in an IMS (IP multimedia subsystem) network, the method comprising:
in response to a call received from a caller party to a called party, the call originated from a POTS device that is not capable of handling IMS protocols, accessing a presence service provider to retrieve presence information about the called party using the IMS protocols, the presence information indicating a current presence state of the called party; and
announcing the current presence state of the called party to the caller party by playing a prerecorded voice message representing the current presence state of the called party.

2. The method of claim 1, further comprising:
interpreting the presence information to determine the current presence state of the called party using the IMS protocols; and
identifying the prerecorded voice message from a pool of prerecorded voice messages in response to the interpretation of the presence information.

3. The method of claim 2, wherein the presence service provider comprises a presence service proxy for providing presence services to a plurality of POTS devices using presence information obtained from a presence server using a session initiated protocol (SIP), and wherein the current presence state is announced by a media server coupled to the presence service proxy.

4. The method of claim 2, wherein the POTS device is communicatively coupled to the IMS network via an IAD/ATA (integrated access device/analog telephone adapter) device, wherein the IAD/ATA device enables the POTS device to access the IMS network.

5. The method of claim 4, further comprising the IAD/ATA device downloading the plurality of prerecorded voice messages, where the announcement of the presence state of the called party is performed by the IAD/ATA device.

6. The method of claim 1, further comprising informing via a MWI (message waiting indicator) signaling scheme the caller party a request to add the caller party to a watch list of other parties of the IMS network.

7. The method of claim 6, further comprising obtaining via a DTMF (dual tone multi-frequency) signaling scheme an agreement and/or a rejection for the request to join the watch list.

8. A machine-readable medium having instructions stored therein, which when executed by a processor, cause the processor to perform a method for providing presence services to POTS (plain old telephony system) telephones in an IMS (IP multimedia subsystem) network, the method comprising:
in response to a call received from a caller party to a called party, the call originated from a POTS device that is not capable of handling IMS protocols, accessing a presence service provider to retrieve presence information about the called party using the IMS protocols, the presence information indicating a current presence state of the called party; and
announcing the current presence state of the called party to the caller party by playing a prerecorded voice message representing the current presence state of the called party.

9. The machine-readable medium of claim 8, wherein the method further comprises:
interpreting the presence information to determine the current presence state of the called party using the IMS protocols; and
identifying the prerecorded voice message from a pool of prerecorded voice messages in response to the interpretation of the presence information.

10. The machine-readable medium of claim 9, wherein the presence service provider comprises a presence service proxy for providing presence services to a plurality of POTS devices using presence information obtained from a presence server using a session initiated protocol (SIP), and wherein the current presence state is announced by a media server coupled to the presence service proxy.

11. The machine-readable medium of claim 9, wherein the POTS device is communicatively coupled to the IMS network via an IAD/ATA (integrated access device/analog telephone adapter) device, wherein the IAD/ATA device enables the POTS device to access the IMS network.

12. The machine-readable medium of claim 11, wherein the method further comprises the IAD/ATA device downloading the plurality of prerecorded voice messages, where the announcement of the presence state of the called party is performed by the IAD/ATA device.

13. The machine-readable medium of claim 8, wherein the method further comprises informing via a MWI (message waiting indicator) signaling scheme the caller party a request to add the caller party to a watch list of other parties of the IMS network.

14. The machine-readable medium of claim 13, wherein the method further comprises obtaining via a DTMF (dual tone multi-frequency) signaling scheme an agreement and/or a rejection for the request to join the watch list.

15. An apparatus for providing presence services to POTS (plain old telephony system) telephones in an IMS (IP multimedia subsystem) network, the apparatus comprising:
a presence service proxy, in response to a call received from a caller party to a called party, the call originated from a POTS device that is not capable of handling IMS protocols, to access a presence service provider to retrieve presence information about the called party using the IMS protocols, the presence information indicating a current presence state of the called party; and
a media server coupled to the presence service proxy to announce the current presence state of the called party to the caller party by playing a prerecorded voice message representing the current presence state of the called party.

16. The apparatus of claim 15, wherein the presence service proxy is configured to interpret the presence information to determine the current presence state of the called party using the IMS protocols, and wherein the presence service proxy is configured to identify the prerecorded voice message from a pool of prerecorded voice messages in response to the interpretation of the presence information.
